(19) United States
(12) Patent Application Publication
(10) Pub. No.: US 2019/0138035 A1
(43) Pub. Date: May 9, 2019

(54) DEVICE FOR MEASURING AND ADJUSTING CONCENTRATION OF SLURRY SOLUTION

(71) Applicant: SEMIROAD CO., LTD, Paju-si, Gyeonggi-do (KR)

(72) Inventor: Hong Sung KIM, Namyangju-si, Gyeonggi-do (KR)

(73) Assignee: SEMIROAD CO., LTD, Paju-si, Gyeonggi-do (KR)

(21) Appl. No.: 16/302,095

(22) PCT Filed: Jun. 20, 2017
(86) PCT No.: PCT/KR2017/006446

§ 371 Date: Nov. 15, 2018

(30) Foreign Application Priority Data
Jun. 21, 2016 (KR) 10-2016-0077327

(51) Int. Cl. G05D 11/13; G01N 21/31; G01N 27/12; G01N 29/22; G01N 29/024

(52) U.S. Cl. CPC G05D 11/138; G01N 21/31; G01N 29/024; G01N 29/222; G01N 27/12

(57) ABSTRACT

A device for measuring the concentration of a slurry solution according to an embodiment of the present invention includes a sensor part including a first sensor for measuring the conductivity of a solution, a second sensor for measuring an ultrasonic wave propagation velocity of the solution, and a third sensor for measuring the absorbance of the solution; and a concentration measurer configured to analyze the conductivity, ultrasonic wave propagation velocity, and absorbance input from the sensor part and measure the concentrations of hydrogen peroxide and a slurry in the solution in real time.

### TECHNICAL FIELD

The present invention relates to a device for measuring and adjusting the concentration of a slurry solution.

### BACKGROUND ART

As a semiconductor device is miniaturized, densified and multilayered, a finer patterning technique is used, a surface structure of the semiconductor device becomes complicated, and steps of insulating interlayer films are also becoming larger. Accordingly, a chemical mechanical polishing (hereinafter referred to as “CMP”) process is used as a representative planarization technique for removing a step of a specific film formed on a semiconductor substrate.

The CMP process is a process of planarizing a wafer surface using a polishing pad and a slurry. More particularly, the CMP process is a polishing process using a slurry containing an abrasive while carrying out orbital motion by bringing a polishing pad and a wafer into contact with each other to mix rotation and linear motions of the polishing pad and the wafer. A slurry used in the CMP process is greatly constituted of abrasive particles, which physically act, and a compound such as an etchant which chemically acts.

Recently, the CMP process has become very important in manufacturing processes of industries such as the semiconductor industry, the LCD industry, the LED industry, and the solar photovoltaic industry. A slurry, which is a very important material in the CMP process, is supplied in a state of being dispersed in a mixed solution of water and hydrogen peroxide. Here, since the concentrations of hydrogen peroxide and a slurry greatly affect the CMP process, it is very important to manage the concentrations of the hydrogen peroxide and the slurry.

So far, slurry solutions used in the semiconductor industry have been measured based on only one measurement principle. In particular, the concentration of hydrogen peroxide in slurry solutions used in the semiconductor industry field was measured only using an ultrasonic principle. However, when the concentration of hydrogen peroxide in a slurry solution is measured only using the ultrasonic principle, the concentration of the slurry may affect a concentration measurement result of the hydrogen peroxide. That is, if the concentration of a slurry is changed although the concentration of hydrogen peroxide is kept constant, an error may occur in a concentration measurement result of the hydrogen peroxide. In addition, the concentration of a slurry in a slurry solution has not been measured in slurry solution measurement methods used in the semiconductor industry so far.

### DISCLOSURE

### Technical Problem

Therefore, the present invention has been made in view of the above problems, and it is one object of the present invention to provide a device for measuring and adjusting the concentration of a slurry solution, the device being capable of measuring the concentrations of hydrogen peroxide and a slurry in a slurry solution in real time when the slurry solution is supplied into a CMP apparatus.

It is another object of the present invention to provide a device for measuring and adjusting the concentration of a slurry solution, the device being capable of adjusting the concentrations of hydrogen peroxide and a slurry in a slurry solution using measured hydrogen peroxide and slurry concentrations.

### Technical Solution

In accordance with an aspect of the present invention, the above and other objects can be accomplished by the provision of a device for measuring the concentration of a slurry solution including a sensor part including a first sensor for measuring the conductivity of a solution, a second sensor for measuring an ultrasonic wave propagation velocity of the solution, and a third sensor for measuring the absorbance of the solution; and a concentration measurer configured to analyze the conductivity, ultrasonic wave propagation velocity, and absorbance input from the sensor part and measure the concentrations of hydrogen peroxide and a slurry in the solution in real time.

Here, the concentration measurer may make Equation 4 using the concentration of the hydrogen peroxide and the concentration and the conductivity of the slurry, Equation 5 using the concentration of the hydrogen peroxide and the concentration and the ultrasonic wave propagation velocity of the slurry, and Equation 6 using the concentration of the hydrogen peroxide and the concentration and the absorbance of the slurry, analyze Equations 4 to 6, and measure the concentration of the hydrogen peroxide and the concentration of the slurry.

Here, the concentration of the hydrogen peroxide and the concentration of the slurry may be measured by any one of a combination of Equations 4 and 5, a combination of Equations 5 and 6, a combination of Equations 4 and 6, and a combination of Equations 4 to 6.

Here, the concentration of the hydrogen peroxide and the concentration of the slurry may be measured through multiple regression analysis.

Here, by the concentration measurer, the concentration of the hydrogen peroxide and the concentration of the slurry may be simultaneously measured in real time.

In accordance with another aspect of the present invention, there is provided a device for measuring and adjusting the concentration of a slurry solution, including a sensor part including a first sensor for measuring the conductivity of a solution, a second sensor for measuring an ultrasonic wave propagation velocity of the solution, and a third sensor for measuring the absorbance of the solution; a concentration measurer configured to analyze the conductivity, ultrasonic wave propagation velocity, and absorbance input from the sensor part and measure the concentrations of hydrogen peroxide and a slurry in the solution in real time; and a concentration adjuster configured to receive input of information on the concentration of the hydrogen peroxide and the concentration of the slurry from the concentration measurer and adjust at least one of the amount of the hydrogen peroxide, the amount of the slurry, and the amount of water such that the concentration of the hydrogen peroxide and the concentration of the slurry are within a predetermined range.

Here, the concentration adjuster may include a controller configured to compare the input hydrogen peroxide and slurry concentrations to the predetermined range and calculate the amount of the hydrogen peroxide, the amount of the slurry, and the amount of the water to be adjusted; a hydrogen peroxide supplier configured to supply hydrogen peroxide according to calculation of the controller; a slurry supplier configured to supply a slurry according to calculation of the controller; and a water supplier configured to supply water according to calculation of the controller.

Here, the concentration adjuster may receive input of information on the concentration of the hydrogen peroxide and the concentration of the slurry in real time.

Here, the concentration adjuster may adjust the concentration of the hydrogen peroxide and the concentration of the slurry in real time.

### Advantageous Effects

Since a device for measuring the concentration of a slurry solution according to an embodiment of the present invention includes a first sensor for measuring the conductivity of a solution, a second sensor for measuring an ultrasonic wave propagation velocity of a solution, and a third sensor for measuring the absorbance of a solution and is capable of analyzing conductivity, an ultrasonic wave propagation velocity, and an absorbance, the concentrations of hydrogen peroxide and a slurry in a solution can be accurately measured.

Since a concentration measurer of the device for measuring the concentration of a slurry solution according to an embodiment of the present invention makes Equation 4 using the concentration of hydrogen peroxide and the concentration and conductivity of a slurry, Equation 5 using the concentration of hydrogen peroxide and the concentration and ultrasonic wave propagation velocity of a slurry, and Equation 6 using the concentration of hydrogen peroxide and the concentration and the absorbance of the slurry, analyzes the equations, and analyzes the concentrations of the hydrogen peroxide and the slurry, the concentrations of hydrogen peroxide and a slurry in a solution can be accurately measured.

Since the device for measuring the concentration of a slurry solution according to an embodiment of the present invention measures the concentrations of hydrogen peroxide and a slurry based on any one of a combination of Equations 4 and 5, a combination of Equations 5 and 6, a combination of Equations 4 and 6, and a combination of Equations 4 to 6, the device can be used for any kind of slurry solutions.

Since the device for measuring the concentration of a slurry solution according to an embodiment of the present invention measures the concentrations of hydrogen peroxide and a slurry based on multiple regression analysis, the concentrations of hydrogen peroxide and a slurry in a solution can be more accurately measured in real time.

Since the device for measuring and adjusting the concentration of a slurry solution according to an embodiment of the present invention includes a sensor part, a concentration measurer, and a concentration adjuster, the concentrations of hydrogen peroxide and a slurry can be measured in real time, and the concentration of the slurry solution can be maintained within a predetermined range by adjusting at least one of the amount of the hydrogen peroxide, the amount of the slurry, and the amount of water to correspond to the concentrations which have been measured in real time. Accordingly, the concentration of a slurry solution used in a CMP process can be maintained constant, and the concentrations of hydrogen peroxide and a slurry in the slurry solution can be maintained constant, thereby preventing defects in the CMP process.

Since the device for measuring and adjusting the concentration of a slurry solution according to an embodiment of the present invention includes a controller configured to compare hydrogen peroxide and slurry concentrations, which have been input, to a predetermined range and calculate the amount of hydrogen peroxide, the amount of a slurry, and the amount of water to be adjusted; a hydrogen peroxide supplier configured to supply hydrogen peroxide according calculation of the controller; a slurry supplier configured to supply a slurry according to calculation of the controller; and a water supplier configured to supply water according to calculation of the controller, the concentrations of hydrogen peroxide and a slurry in a slurry solution can be accurately adjusted.

Since the concentration adjuster of the device for measuring and adjusting the concentration of a slurry solution according to an embodiment of the present invention adjusts the concentrations of hydrogen peroxide and a slurry in real time, the concentrations of hydrogen peroxide and a slurry in a slurry solution used in a CMP process can be maintained constant in real time, thereby preventing defects in a CMP process.

### DESCRIPTION OF DRAWINGS

FIG. 1 is a schematic diagram of a CMP process system to which a device for measuring and adjusting the concentration of a slurry solution according to an embodiment of the present invention is applied.

FIG. 2 is a schematic diagram illustrating a device for measuring the concentration of a slurry solution according to a first example of the present invention and a device for measuring and adjusting the concentration of a slurry solution to which the device is applied.

FIG. 3 is a schematic diagram illustrating a device for measuring the concentration of a slurry solution according to a second example of the present invention and a device for measuring and adjusting the concentration of a slurry solution to which the device is applied.

FIG. 4 is a schematic diagram illustrating a concentration adjuster and a manufacturing tank according to an embodiment of the present invention.

FIG. 5 is a graph illustrating changes in the concentration of hydrogen peroxide during natural evaporation of a slurry solution.

FIG. 6 is a graph illustrating changes in the concentration of hydrogen peroxide when only a slurry is added to a slurry solution.

FIG. 7 is a graph illustrating changes in the concentration of hydrogen peroxide when water is added to a slurry solution.

### MODES OF THE INVENTION

Hereinafter, specific embodiments of the present invention are described with reference to the attached drawings. These embodiments are described in sufficient detail to enable those skilled in the art to practice the invention. It should be understood that the various embodiments of the present invention may be different but need not be mutually exclusive. For example, certain features, structures, and characteristics described herein may be implemented in other embodiments without departing from the spirit and scope of the invention in connection with one embodiment. Also, it should be understood that the locations or arrangements of the individual components of each disclosed embodiment may be varied without departing from the spirit and scope of the present invention. The following detailed description is, therefore, not provided for limitation, and the scope of the present invention is to be limited only by the appended claims and equivalents thereof, if properly explained. In the drawings, like reference numerals refer to the same or similar functions throughout the several views.

### FIRST EXAMPLE

A slurry solution mainly used in a semiconductor CMP process includes hydrogen peroxide and a slurry. Hydrogen peroxide mainly serves to chemically react and acts as a cleaning agent. A slurry physically (mechanically) acts as a polishing agent. The concentrations of hydrogen peroxide and a slurry in a slurry solution are varied depending upon a film that is subjected to a CMP process. In particular, the concentration and type of a slurry are varied depending upon a CMP process type. As such, the concentration of hydrogen peroxide and the concentration and type of a slurry, which are included in a slurry solution used for CMP, may be varied.

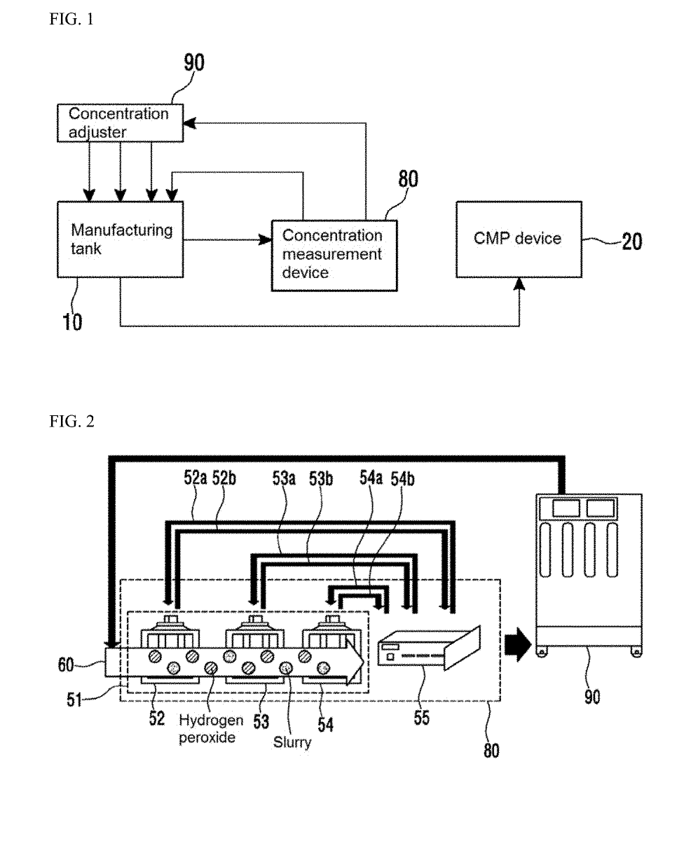

FIG. 1 illustrates a schematic diagram of a CMP process system to which a device for measuring and adjusting the concentration of a slurry solution according to an embodiment of the present invention is applied.

Referring to FIG. 1, a CMP process system to which a device for measuring the concentration of a slurry solution according to an embodiment of the present invention is applied may include a manufacturing tank 10 for manufacturing a slurry solution at a predetermined concentration, a CMP device 20 for performing a CMP process to which a slurry solution is supplied, and a concentration measurement device 80 for measuring the concentrations of hydrogen peroxide and a slurry included in a slurry solution in the manufacturing tank 10. In addition, the CMP process system to which the device for measuring and adjusting the concentration of a slurry solution according to an embodiment of the present invention is applied may further include a concentration adjuster 90 for adjusting the concentrations of hydrogen peroxide and a slurry included in a slurry solution in the manufacturing tank 10.

FIG. 2 is a schematic diagram illustrating a device for measuring the concentration of a slurry solution according to a first example of the present invention and a device for measuring and adjusting the concentration of a slurry solution to which the device is applied.

Referring to FIGS. 1 and 2, the device 80 for measuring the concentration of a slurry solution according to the first example includes a sensor part 51 and a concentration measurer 55. The sensor part 51 includes a first sensor 52 for measuring the conductivity of a solution, a second sensor 53 for measuring an ultrasonic wave propagation velocity of a solution, and a third sensor 54 for measuring the absorbance of a solution. A concentration measurer 55 analyzes the conductivity, ultrasonic wave propagation velocity, and absorbance that are input from the sensor part 51 to measure the concentrations of hydrogen peroxide and a slurry in a solution in real time.

In particular, the concentration measurer 55 respectively transmits driving signals 52a, 53a, and 54a to the first to third sensors 52, 53, and 54 and analyzes data 52b, 53b, and 54b input from the first to third sensors 52, 53, and 54 to measure the concentrations of hydrogen peroxide and a slurry in a slurry solution. Here, the first sensor is a sensor for measuring the conductivity of a solution, the second sensor is a sensor for measuring a sensor for measuring an ultrasonic wave propagation velocity of a solution, and the third sensor is a sensor for measuring UV absorption of a solution.

As illustrated in FIGS. 1 and 2, a slurry solution of the manufacturing tank 10 flows along a circulation flow path 60 between the sensor part 51 of the concentration measurement device 80 and the manufacturing tank 10. The first to third sensors 52, 53, and 54 of the sensor part 51 respectively measure the electrical conductivity, ultrasonic wave propagation velocity, and absorbance of a slurry solution flowing along the circulation flow path 60. Here, hydrogen peroxide in the circulation flow path 60 is illustrated as a circle with a hatched pattern, and a slurry in the circulation flow path 60 is illustrated as a circle with a dotted pattern, for the sake of understanding.

The first to third sensors 52, 53, and 54, which have received the driving signals 52a, 53a, and 54a, respectively transmit signals for measuring the concentrations of hydrogen peroxide and a slurry to a slurry solution and receive returned signals to measure the concentrations of the hydrogen peroxide and the slurry. For example, the first sensor 52 transmits an electrical signal to the slurry solution to measure the electrical conductivity of the slurry solution, the second sensor 53 transmits a ultrasonic signal to the slurry solution to measure an ultrasonic wave propagation velocity of the slurry solution, and the third sensor 54 transmits a UV light source signal to the slurry solution to measure the absorbance of the slurry solution.

More particularly, the first sensor 52 may measure electrical conductivity that is changed depending upon the physical properties and amount of a solute present in a slurry solution. Here, the first sensor 52 is greatly affected by the concentration or intensity of ions and does not easily detect a change in the concentration of a nonconductive material. The second sensor 53 may measure the phenomenon in which the properties and amount of a solute present in the slurry solution interfere with an ultrasonic signal, which results in a change in velocity or magnitude of the ultrasonic signal. Here, the second sensor 53 is greatly affected by the sizes or density of particles. The third sensor 54 may measure the phenomenon in which the properties and amount of a solute present in a slurry solution interfere with light signals, which results in a change in the reflection angle, intensity, amount, and the like of light or an occurring spectroscopic phenomenon. Here, the third sensor 54 is affected by inherent physical and energy characteristics of a solute. Materials of such light sources are various and may be varied to correspond to light source types.

Referring to FIG. 2, the concentration measurer 55 of the concentration measurement device 80 receives input of the electrical conductivity data 52b, ultrasonic wave propagation velocity data 53b, and absorbance data 54b of the slurry solution which have been measured in the sensor part 51.

The device for measuring the concentration of a slurry solution according to an embodiment may find the concentrations of hydrogen peroxide and a slurry by performing multiple regression analysis on the electrical conductivity data 52b, ultrasonic wave propagation velocity data 53b, and absorbance data 54b of the slurry solution. Particularly, the concentration measurer 55 according to an embodiment may measure the concentrations of hydrogen peroxide and a slurry in the slurry solution based on a predetermined relationship between the electrical conductivity data 52b, ultrasonic wave propagation velocity data 53b, and absorbance data 54b measured in the sensor part 51 and the concentration of hydrogen peroxide in the slurry solution and a predetermined relationship between the measured electrical conductivity data 52b, ultrasonic wave propagation velocity data 53b, and absorbance data 54b and the concentration of the slurry in the slurry solution. Here, the predetermined relationships may be those previously stored in a database in the concentration measurer 55.

More particularly, when the concentration of hydrogen peroxide to be measured is X, the concentration of a slurry to be measured is Y, and the concentration of water to be measured is Z, the concentration of a slurry solution may be represented by Equation 1 below:

aX+bY+cZ=100 <Equation 1>

wherein a, b, and c are coefficients changed according to electrical conductivity, an ultrasonic wave propagation velocity, and an absorbance, respectively.

Here, since Z=100−X−Y, Equation 1 may be represented by Equation 2 below:

aX+bY+c(100−X−Y)=100 <Equation 2>

Equation 1 may be represented by Equation 3 by summarizing the concentration of hydrogen peroxide and the concentration of a slurry:

(a−c)X+(b−c)Y=100(1−c) <Equation 3>

Here, when A=a−c, B=b−c, and C=100(1−c), Equations 4 to 6 below may be represented according to electrical conductivity, an ultrasonic wave propagation velocity, and an absorbance. A predetermined relationship between the concentration (X) of hydrogen peroxide and the concentration (Y) of a slurry according to electrical conductivity data may be represented by Equation 4 below:

AX+BY=C <Equation 4>

wherein A is a coefficient of the concentration (X) of hydrogen peroxide changed according to the electrical conductivity data 52b, B is a coefficient of the concentration (Y) of a slurry changed according to the electrical conductivity data 52b, and C is a constant value determined by the measured electrical conductivity data 52b. For example, C may be a measured electrical conductivity value (CD) of hydrogen peroxide and a slurry at a specific concentration.

In addition, a predetermined relationship between the concentration (X) of hydrogen peroxide and the concentration (Y) of a slurry according to the ultrasonic wave propagation velocity data 53b may be represented by Equation 5 below:

A′X+B′Y=C′ <Equation 5>

wherein A′ is a coefficient of the concentration (X) of hydrogen peroxide changed according to the ultrasonic wave propagation velocity data 53b, B′ is a coefficient of the concentration (Y) of a slurry changed according to the ultrasonic wave propagation velocity data 53b, and C′ is a constant value determined by the measured ultrasonic wave propagation velocity data 53b. For example, C′ may be a measured ultrasonic wave propagation velocity value (US) of hydrogen peroxide and a slurry at a specific concentration.

In addition, a predetermined relationship between the concentration (X) of hydrogen peroxide and the concentration (Y) of a slurry according to the absorbance data 54b may be represented by Equation 6 below:

A″X+B″Y=C″ <Equation 6>

Here, A″ is a coefficient of the concentration (X) of hydrogen peroxide changed according to the absorbance data 54b, B″ is a coefficient of the concentration (Y) of a slurry changed according to the absorbance data 54b, and C″ is a constant value determined by the measured absorbance data 54b. For example, C″ may be a measured absorbance measurement value (ABS) of hydrogen peroxide and a slurry at a specific concentration.

Coefficients A, B, A′, B′, A″, B″ may be found through an experiment using Equations 4 to 6. For example, the electrical conductivity of a slurry solution may be measured while changing known concentrations of hydrogen peroxide and a slurry, which may be represented by Equation 7 below:

$${AX}_{0} + {BY}_{0} = {C}_{00} \\ {AX}_{0} + {BY}_{1} = {C}_{01} \\ {AX}_{1} + {BY}_{0} = {C}_{10} \\ … \\ {AX}_{n} + {BY}_{n} = {C}_{nn} \qquad < Equation 7 >$$

Coefficients A and B satisfying all of the expressions of Equation 7 may be found.

In addition, an ultrasonic wave propagation velocity of a slurry solution may be measured while changing known concentrations of hydrogen peroxide and a slurry, which may be represented by Equation 8 below:

$${A}^{′} {X}_{0} + {B}^{′} {Y}_{0} = {C}_{00}^{′} \\ {A}^{′} {X}_{0} + {B}^{′} {Y}_{1} = {C}_{01}^{′} \\ {A}^{′} {X}_{1} + {B}^{′} {Y}_{0} = {C}_{10}^{′} \\ … \\ {A}^{′} {X}_{n} + {B}^{′} {Y}_{n} = {C}_{nn}^{′} \qquad < Equation 8 >$$

Coefficients A′ and B′ satisfying all of the expressions of Equation 8 may be found.

In addition, the absorbance of a slurry solution may be measured while changing known concentrations of hydrogen peroxide and a slurry, which may be represented by Equation 9 below:

$${A}^{″} {X}_{0} + {B}^{″} {Y}_{0} = {C}_{00}^{″} \\ {A}^{″} {X}_{0} + {B}^{″} {Y}_{1} = {C}_{01}^{″} \\ {A}^{″} {X}_{1} + {B}^{″} {Y}_{0} = {C}_{10}^{″} \\ … \\ {A}^{″} {X}_{n} + {B}^{″} {Y}_{n} = {C}_{nn}^{″} \qquad < Equation 8 >$$

Coefficients A″ and B″ satisfying all of the expressions of Equation 9 may be found.

When coefficients are found, a matching table including at least one of the electrical conductivity C, the ultrasonic wave propagation velocity C′, and the absorbance C″ measured through an experiment and at least one of the coefficient pairs, {A, B}, {A′, B′}, and {A″, B″}, found according to Equations 7 to 9 may be generated in advance.

Next, when it is desired to know the concentration (X) of hydrogen peroxide and the concentration (Y) of a slurry in a slurry solution, coefficients may be extracted, using the electrical conductivity data, ultrasonic wave propagation velocity data, and the absorbance data obtained from the predetermined slurry solution, based on the matching table generated in advance.

As an embodiment, data that matches the measured electrical conductivity data, ultrasonic wave propagation velocity data, and absorbance data may be found in the matching table, and a coefficient corresponding to the data may be extracted.

As another embodiment, when data that matches the measured electrical conductivity data, ultrasonic wave propagation velocity data, and absorbance data is absent, data most similar to the measured electrical conductivity data, ultrasonic wave propagation velocity data, and absorbance data may be found from the matching table to extract a coefficient corresponding to the data.

In addition, the concentration (X) of hydrogen peroxide and the concentration (Y) of the slurry may be found using the measured electrical conductivity data, ultrasonic wave propagation velocity data, and absorbance data and the extracted coefficient.

For example, when a slurry solution showing electrical conductivity and an ultrasonic wave propagation velocity is used, the concentration (X) of hydrogen peroxide and the concentration (Y) of a slurry may be represented by Equation 10 below by summarizing Equations 4 and 5:

$$X = \frac{{B}^{′}}{{AB}^{′} - {A}^{′} B} C - \frac{B}{{AB}^{′} - {A}^{′} B} {C}^{′} \\ Y = \frac{{A}^{′}}{{A}^{′} B - {AB}^{′}} C - \frac{A}{{A}^{′} B - {AB}^{′}} {C}^{′} \qquad < Equation 10 >$$

Accordingly, a summarized equation of the concentration (X) of hydrogen peroxide and the concentration (Y) of a slurry summarized using Equations 4 to 6 in this manner may be generated as in Equation 11 below:

X=f(US,CD,ABS)

Y=g(US,CD,ABS) <Equation 11>

wherein US is ultrasonic wave propagation velocity data, CD is electrical conductivity data, and ABS is absorbance data.

The concentration of hydrogen peroxide and the concentration of the slurry may be finally measured using the summarized equation. When the slurry exhibits conductivity, a summarized equation is generated using two or more of Equations 4 to 6. On the other hand, when the slurry does not exhibit conductivity, a summarized equation may be generated using Equations 5 and 6.

Further, when a slurry solution has conductivity, the concentration X of hydrogen peroxide may be represented as a function of only CD and ABS, and the concentration Y of a slurry may be represented as a function of only US and CD, as follows, so as to increase the accuracy of concentration measurement in a use environment of the slurry solution including hydrogen peroxide and a slurry:

X=f(CD,ABS)

Y=g(US,CD) <Equation 12>

Conversely, the concentration X of hydrogen peroxide may be represented as a function of only US and CD, and the concentration Y of a slurry may be represented as a function of only CD and ABS.

In addition, due to the interaction of a slurry and hydrogen peroxide in the case of a mixture including the slurry and hydrogen peroxide, equations for finding the concentrations of the hydrogen peroxide and the slurry may include constants D and E.

$$X = \frac{{B}^{′}}{{AB}^{′} - {A}^{′} B} C - \frac{B}{{AB}^{′} - {A}^{′} B} {C}^{′} + D \\ Y = \frac{{A}^{′}}{{A}^{′} B - {AB}^{′}} C - \frac{A}{{A}^{′} B - {AB}^{′}} {C}^{′} + E \qquad < Equation 13 >$$

wherein each of D and E is a constant.

Based on the above background, calculation formulas of a slurry concentration and a hydrogen peroxide concentration derived through an actual experiment are summarized in [Table 1] below:

TABLE 1

| | | Concentration (X) of hydrogen |
|---|---|---|
| Items | Concentration (Y) of slurry | peroxide |
| Slurry 1 | 86.612 * ABS + 86.612 * | 16.72 * US − 12.8 * CD − 6.7 * |
| | CD + 42.4396 * US | ABS |
| Slurry 2 | 4.393 * ABS − 6.472 * | 1.3 * ABS − US + 0.557 |
| | US + 0.59 | |
| Slurry 3 | 44.916 * CD − 21.887 * | 5.32 * CD + 3.6 * US − 1.23 |
| | ABS + 1.21 | |

As shown in [Table 1], in a slurry solution, Slurry 1, electrical conductivity, an ultrasonic wave propagation velocity, and an absorbance are all measured to find the concentrations of hydrogen peroxide and a slurry. In a slurry solution, Slurry 2, an ultrasonic wave propagation velocity and an absorbance were measured to find the concentrations of hydrogen peroxide and a slurry. In a slurry solution Slurry 3, electrical conductivity and an absorbance were measured to find the concentration of a slurry, and electrical conductivity and an ultrasonic wave propagation velocity were measured to find the concentration of hydrogen peroxide.

Since a relationship between the concentration (X) of hydrogen peroxide and the concentration (Y) of a slurry may be represented by the three equations, the concentration (X) of hydrogen peroxide and the concentration (Y) of the slurry may be found by any one of a combination of Equations 4 and 5, a combination of Equations 5 and 6, a combination of Equations 4 and 6, or a combination of Equations 4 to 6.

As an embodiment, when a slurry exhibiting conductivity is used, an equation wherein Y is the only unknown may be obtained by rearranging Equation 4 to an equation based on X, and then substituting X in Equation 5. Accordingly, the concentration (Y) of a slurry may be found by summarizing the equation wherein an unknown is only Y. Next, when the concentration (Y) of a slurry is substituted in Equation 4 or 5, an equation wherein X is the only unknown may be obtained. Accordingly, the concentration (X) of hydrogen peroxide may be found by summarizing the equation wherein an unknown is only X.

As another embodiment, when a slurry not exhibiting conductivity is used, an equation wherein Y is the only unknown may be obtained by rearranging Equation 5 to an equation based on X, and then substituting X in Equation 6. Accordingly, the concentration (Y) of a slurry may be found by summarizing the equation wherein Y is the only unknown. Next, an equation wherein X is the only unknown may be obtained by inputting the concentration (Y) of a slurry into Equation 5 or 6. Accordingly, the concentration (X) of hydrogen peroxide may be found by summarizing the equation wherein X is the only unknown.

The device 80 for measuring the concentration of a slurry solution according to an embodiment may continuously measure the conductivity, ultrasonic wave propagation velocity, and absorbance, input from the sensor part 51, through the circulation flow path 60, thus measuring the concentrations of hydrogen peroxide and the slurry in the slurry solution in real time. In addition, the device 80 for measuring the concentration of a slurry solution according to an embodiment measures the concentrations of hydrogen peroxide and a slurry by performing multiple regression analysis on the electrical conductivity, ultrasonic wave propagation velocity, and absorbance data of a slurry solution measured from different sensors, thus the concentrations of hydrogen peroxide and a slurry may be measured at the same time.

As such, since the device 80 for measuring the concentration of a slurry solution according to an embodiment analyzes conductivity, an ultrasonic wave propagation velocity, and an absorbance measured using the first sensor for measuring the conductivity of a solution, the second sensor for measuring an ultrasonic wave propagation velocity of a solution, and the third sensor for measuring the absorbance of a solution, the concentrations of hydrogen peroxide and the slurry in the solution may be accurately measured.

In addition, the device for measuring the concentration of a slurry solution according to an embodiment may measure the concentrations of hydrogen peroxide and a slurry in a slurry solution at the same time. Accordingly, the concentrations of hydrogen peroxide and a slurry may be accurately measured at the same time by preventing a change in the concentration of a slurry from inducing mismeasurement of the concentration of hydrogen peroxide.

In addition, in the concentration measurer 55, Equation 4 is made using the concentration of hydrogen peroxide and the concentration and conductivity of a slurry, Equation 5 is made using the concentration of hydrogen peroxide and the concentration and ultrasonic wave propagation velocity of a slurry, Equation 6 is made using the concentration of hydrogen peroxide and the concentration and absorbance of a slurry, and the concentrations of hydrogen peroxide and the slurry are measured by analyzing Equations 4 to 6. Accordingly, the concentrations of hydrogen peroxide and a slurry in a solution may be more accurately measured.

Referring to FIGS. 1 and 2, the device for measuring and adjusting the concentration of a slurry solution according to an embodiment includes the concentration measurement device 80 and the concentration adjuster 90. The concentration measurement device 80 includes the sensor part 51 including the first sensor 52 for measuring the conductivity of a solution, the second sensor 53 for measuring an ultrasonic wave propagation velocity of a solution, and the third sensor 54 for measuring the absorbance of a solution; and the concentration measurer 55 analyzing the conductivity data 52b, ultrasonic wave propagation velocity data 53b and absorbance data 54b input from the sensor part 51 to measure the concentrations of hydrogen peroxide and a slurry in the solution in real time. The concentration adjuster 90 receives input of information on the concentrations of hydrogen peroxide and a slurry from the concentration measurement device 80 and adjusts at least one of the amount of hydrogen peroxide, the amount of a slurry, and the amount of water such that the concentrations of hydrogen peroxide and a slurry are within a predetermined range.

The concentration adjuster 90 will be described below with reference to FIG. 4.

### SECOND EMBODIMENT

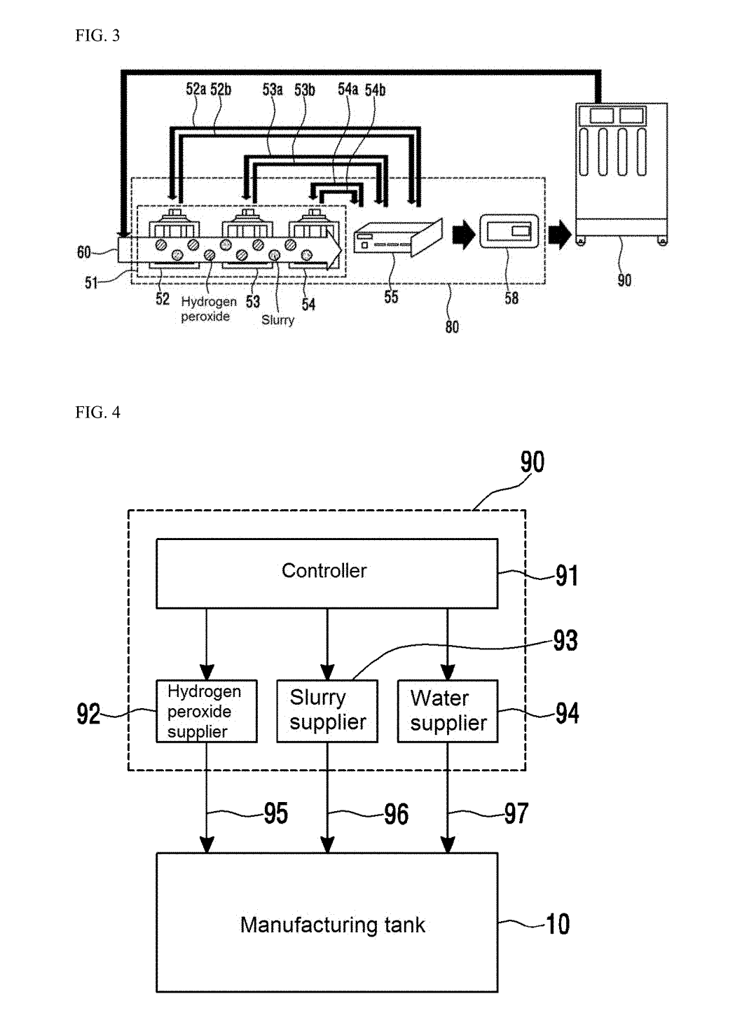

FIG. 3 is a schematic diagram illustrating a device for measuring the concentration of a slurry solution according to a second example of the present invention and a device for measuring and adjusting the concentration of a slurry solution to which the device is applied.

Referring to FIGS. 1 and 3, a device 80 for measuring the concentration of a slurry solution according to the second example includes a sensor part 51, a concentration measurer 55, and a display 58. The sensor part 51 includes a first sensor 52 for measuring the conductivity of a solution, a second sensor 53 for measuring an ultrasonic wave propagation velocity of a solution, and a third sensor 54 for measuring the absorbance of a solution. The concentration measurer 55 analyzes the conductivity, ultrasonic wave propagation velocity, and absorbance that are input from the sensor part 51 to measure the concentrations of hydrogen peroxide and a slurry in a solution in real time. The display 58 receives input of information on the concentrations of hydrogen peroxide and a slurry in a slurry solution from the concentration measurer 55 and displays the received concentrations.

In addition, the device for measuring and adjusting the concentration of a slurry solution according to the second example includes the concentration measurement device 80 and a concentration adjuster 90. The concentration adjuster 90 receives input of information on the concentrations of hydrogen peroxide and a slurry from the concentration measurement device 80 and adjusts at least one of the amount of hydrogen peroxide, the amount of a slurry, and the amount of water such that the concentrations of hydrogen peroxide and a slurry are within a predetermined range.

Here, since the sensor part 51 and the concentration measurer 55 have been described in the first example, description thereof is omitted, and only the display 58 will be described below.

The display 58 may display information on the concentrations of hydrogen peroxide and a slurry input from the concentration measurer 55 so as to adjust the concentration of a slurry solution.

As such, since the display 58 of the device for measuring the concentration of a slurry solution according to the second example receives input of information on the concentrations of hydrogen peroxide and a slurry in a slurry solution and displays the input concentrations, a user may advantageously confirm the state of the slurry solution.

The following description of a concentration adjuster is applied to the first and second examples.

FIG. 4 is a schematic diagram illustrating a concentration adjuster and a manufacturing tank according to an embodiment of the present invention.

Referring to FIG. 4, a concentration adjuster 90 may include a controller 91, a hydrogen peroxide supplier 92, a slurry supplier 93, and a water supplier 94. The controller 91 compares the concentrations of hydrogen peroxide and a slurry, which have been input, to a predetermined range and calculates the amount of hydrogen peroxide, the amount of a slurry, and the amount of water to be adjusted. The hydrogen peroxide supplier 92 supplies hydrogen peroxide according to calculation of the controller 91. the hydrogen peroxide supplier 92 is connected to the manufacturing tank 10 through a flow path 95. The slurry supplier 93 supplies a slurry according to calculation of the controller 91. The slurry supplier 93 is connected to the manufacturing tank 10 through a flow path 96. The water supplier 94 supplies water according to calculation of the controller 91. The water supplier 94 is connected to the manufacturing tank 10 through a flow path 97.

The concentration adjuster 90 may receive input of information on the concentrations of hydrogen peroxide and a slurry from the concentration measurer 55 and control at least one of the amount of hydrogen peroxide, the amount of a slurry, and the amount of water through the hydrogen peroxide supplier 92, the slurry supplier 93, and the water supplier 94, respectively connected to the manufacturing tank 10, such that the concentrations of the hydrogen peroxide and the slurry are within a predetermined range. Here, the concentration adjuster 90 may receive input of information on the concentrations of the hydrogen peroxide and the slurry from the concentration measurer 55 in real time. In addition, the concentration adjuster 90 may adjust the concentrations of the hydrogen peroxide and the slurry in real time. In addition, a predetermined range of the concentration of the hydrogen peroxide and a predetermined range of the concentration of the slurry may be previously stored in the concentration adjuster 90, and may be transmitted to the concentration adjuster 90 after being previously stored in the concentration measurer 55.

Particularly, the controller 91 compares the concentration of hydrogen peroxide, which has been input, to a predetermined range thereof and the concentration of a slurry, which has been input, to a predetermined range thereof. Here, when the input hydrogen peroxide concentration is outside the predetermined range thereof, the amount of hydrogen peroxide, the amount of the slurry, and the amount of water to be supplied to the manufacturing tank 10 may be calculated such that the hydrogen peroxide concentration is present within the predetermined range thereof. In addition, when the input slurry concentration is outside the predetermined range thereof, the amount of hydrogen peroxide, the amount of the slurry, and the amount of water to be supplied may be calculated such that the slurry concentration is present within the predetermined range thereof.

As an embodiment, when the concentration of hydrogen peroxide is outside the predetermined range, hydrogen peroxide is supplied from the hydrogen peroxide supplier 92 to the manufacturing tank 10 to increase the concentration of hydrogen peroxide, or water is supplied from the water supplier 94 to lower the concentration of hydrogen peroxide. When the concentration of the slurry is outside the predetermined range, the slurry is supplied from the slurry supplier 93 to the manufacturing tank 10 to increase the concentration of the slurry, or water is supplied from the water supplier 94 to lower the concentration of the slurry.

In a CMP process, the CMP process may fail when the concentration of hydrogen peroxide or the concentration of a slurry is changed. Accordingly, in a CMP process, it is a very important process parameter to maintain the concentrations of hydrogen peroxide and a slurry in a slurry solution constant. Therefore, in a process of supplying the slurry solution, it is a very important task to accurately measure and adjust the concentration of a slurry solution.

As such, the device for measuring and adjusting the concentration of a slurry solution according to an embodiment may measure the concentrations of hydrogen peroxide and a slurry in real time and adjust at least one of the amount of hydrogen peroxide, the amount of the slurry, and the amount of water to correspond to the concentrations of hydrogen peroxide and the slurry measured in real time such that the concentration of the slurry solution is maintained within a predetermined range in real time. Accordingly, the concentration of a slurry solution used in a CMP process may be maintained constant and the concentrations of hydrogen peroxide and a slurry in the slurry solution may be maintained constant, thereby preventing defects in the CMP process.

Hereinafter, a conventional measurement method of only measuring ultrasonic wave propagation and a measurement method using the device for measuring the concentration of a slurry solution according to an embodiment of the present invention will be described in comparison with each other.

The conventional slurry concentration method is constituted of one sensor for concentration measurement. In most conventional slurry concentration methods, ultrasonic wave propagation is measured and only the concentration of hydrogen peroxide in a slurry solution is measured. In some of the conventional slurry concentration methods, only the concentration of hydrogen peroxide in a slurry solution is measured using a refractive index meter. However, since a slurry solution is a two-component solution including hydrogen peroxide and a slurry, a concentration measurement result of hydrogen peroxide is affected by the concentration of a slurry when only the concentration of hydrogen peroxide is measured using only one sensor for concentration measurement. Accordingly, it is difficult to accurately measure the concentration of hydrogen peroxide. That is, although the concentration of hydrogen peroxide remains the same, the concentrations of hydrogen peroxide may be differently measured as the concentrations of slurries are changed.

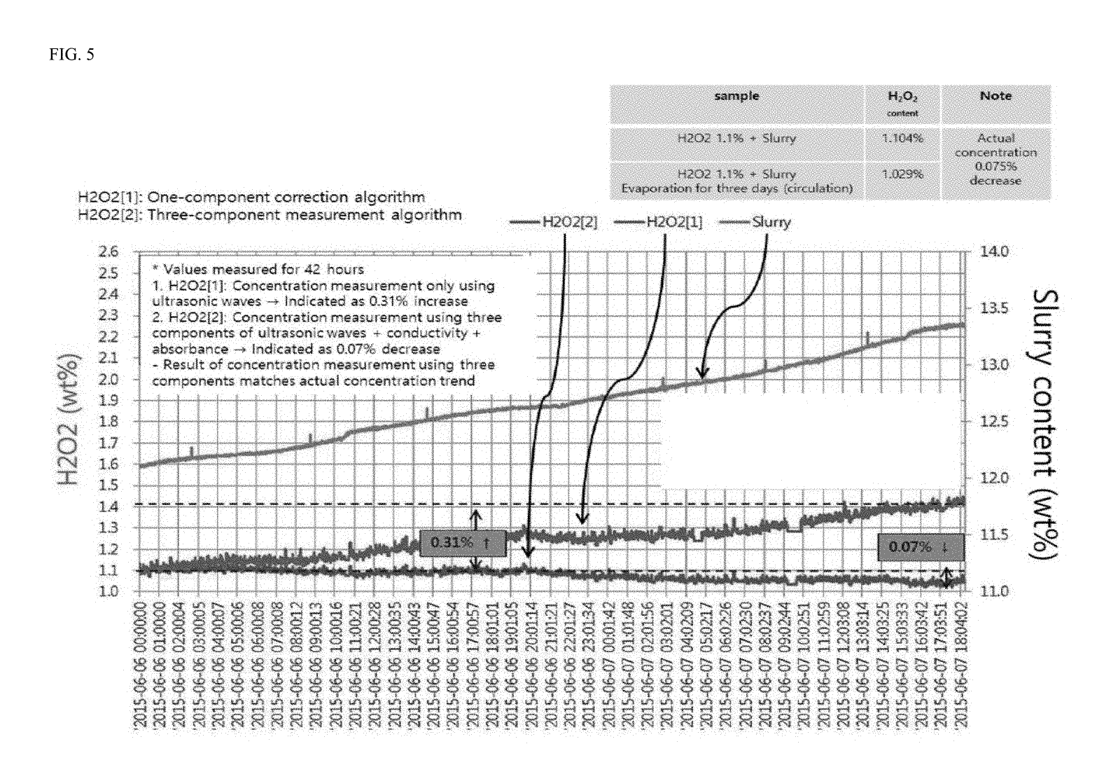

FIG. 5 is a graph illustrating changes in the concentration of hydrogen peroxide during natural evaporation of a slurry solution. Here, a middle line marked with H2O2[1] shows a result of a conventional method of only measuring ultrasonic wave propagation, a bottom line marked with H2O2[2] shows a result measured using the device for measuring and adjusting the concentration of a slurry solution according to an embodiment of the present invention, and a top line marked with Slurry shows the concentration of a slurry.

FIG. 5 is an example showing that the concentration of hydrogen peroxide may be miscalculated due to a change in the concentration of a slurry during measurement of the concentration of hydrogen peroxide in a slurry solution. When a certain amount of slurry solution spontaneously evaporates, hydrogen peroxide and water in the slurry solution evaporate, but a slurry is concentrated. Referring to FIG. 5, while the actual concentration of hydrogen peroxide is reduced due to evaporation of hydrogen peroxide and concentration of a slurry, the concentration of hydrogen peroxide is measured as increasing by the conventional method because the concentration of a slurry affects a concentration measurement result of hydrogen peroxide. In the measurement method according to the present invention, a result similar to an actual concentration is exhibited.

As such, while the conventional method of only measuring ultrasonic wave propagation may cause miscalculation, the device for measuring and adjusting the concentration of a slurry solution according to an embodiment of the present invention allows accurate concentration measurement although a solution containing a slurry evaporates.

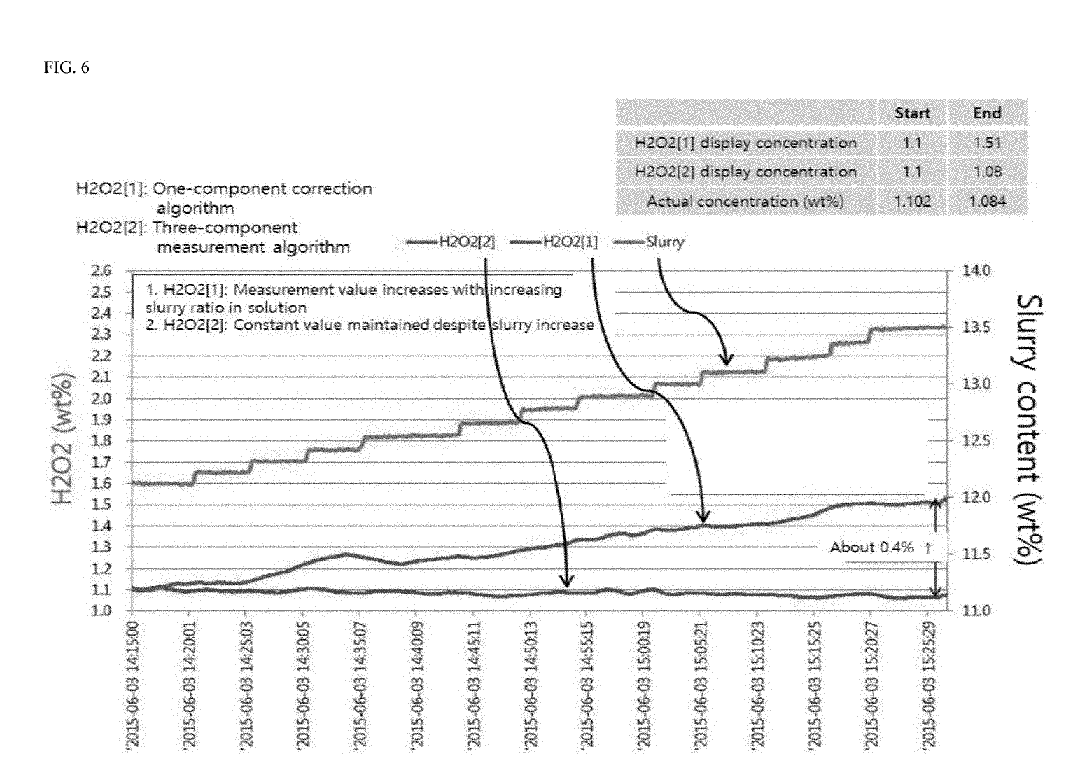

FIG. 6 is a graph illustrating changes in the concentration of hydrogen peroxide when only a slurry is added to a slurry solution. Here, a middle line marked with H2O2[1] shows a result of a conventional method of only measuring ultrasonic wave propagation, a bottom line marked with H2O2[2] shows a result measured using the device for measuring and adjusting the concentration of a slurry solution according to an embodiment of the present invention, and a top line marked with Slurry shows the concentration of a slurry. In addition, an actual concentration was measured using a neutralization assay.

FIG. 6 is another example showing that the concentration of hydrogen peroxide may be miscalculated due to a change in the concentration of a slurry during measurement of the concentration of hydrogen peroxide in a slurry solution. When a certain amount of hydrogen peroxide is maintained and only a slurry is added, it should be measured that the concentration of hydrogen peroxide is maintained and only the concentration of a slurry increases. However, referring to FIG. 6, while the actual concentration of hydrogen peroxide should be measured as being reduced because the concentration of hydrogen peroxide is maintained and only the concentration of a slurry increases, the conventional method of only measuring ultrasonic wave propagation measures the concentration of hydrogen peroxide as increasing. On the other hand, when the device for measuring and adjusting the concentration of a slurry solution according to an embodiment of the present invention is used, a result almost similar to the actual concentration is exhibited.

As such, while the conventional method of only measuring ultrasonic wave propagation may cause miscalculation, the device for measuring and adjusting the concentration of a slurry solution according to an embodiment of the present invention allows accurate hydrogen peroxide concentration measurement although the concentration of a slurry is changed.

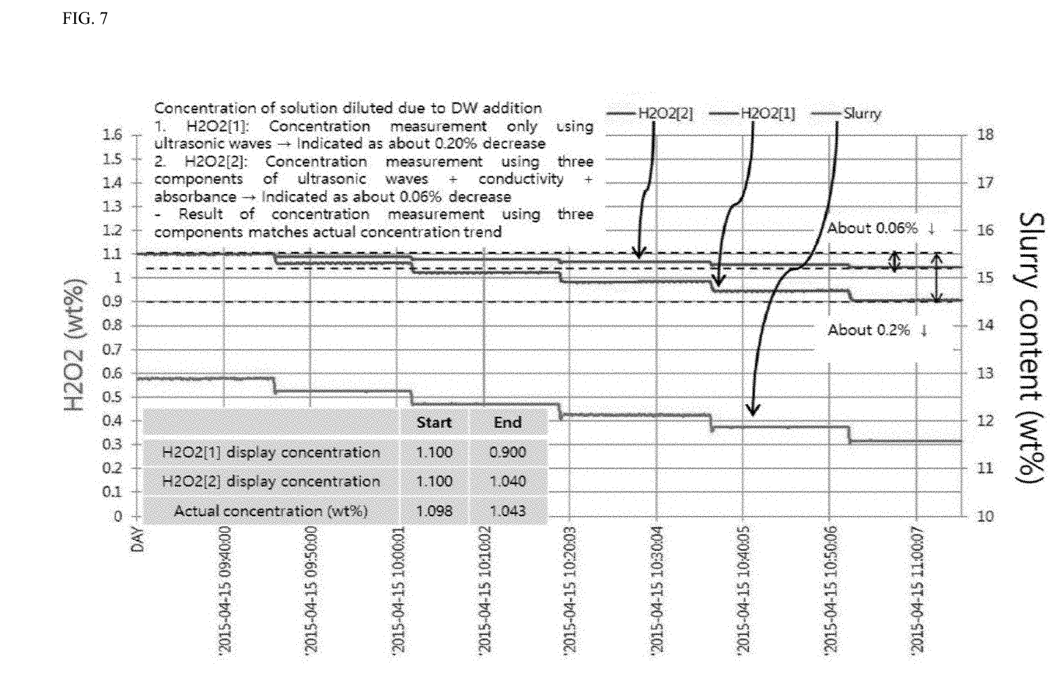

FIG. 7 is a graph illustrating changes in the concentration of hydrogen peroxide when water is added to a slurry solution. Here, a middle line marked with H2O2[1] shows a result of a conventional method of only measuring ultrasonic wave propagation, a top line marked with H2O2[2] shows a result measured using the device for measuring and adjusting the concentration of a slurry solution according to an embodiment of the present invention, and a bottom line marked with Slurry shows the concentration of a slurry. In addition, an actual concentration was measured using a neutralization assay FIG. 7 is another example showing that the concentration of hydrogen peroxide may be miscalculated due to a change in the concentration of water during measurement of the concentration of hydrogen peroxide in a slurry solution. Referring to FIG. 7, although the conventional method of only measuring ultrasonic wave propagation measures the concentration of hydrogen peroxide as being greatly reduced when pure water (DI water) is added to certain amounts of hydrogen peroxide and slurry, an actual hydrogen peroxide concentration reduction amount is very small. That is, the conventional method of only measuring ultrasonic wave propagation causes a measurement error. On the other hand, when the device for measuring and adjusting the concentration of a slurry solution according to an embodiment of the present invention is used, a result almost similar to the actual concentration is exhibited.

As such, while the conventional method of only measuring ultrasonic wave propagation may cause an inaccurate measurement result, the device for measuring and adjusting the concentration of a slurry solution according to an embodiment of the present invention allows accurate hydrogen peroxide concentration measurement.

As such, when the conventional method of only measuring ultrasonic wave propagation is used to measure the concentration of a two-component solution including hydrogen peroxide and a slurry, a change in the concentration of the slurry causes mismeasurement of the concentration of hydrogen peroxide upon measurement of the concentration of hydrogen peroxide. In addition, the conventional method only measures the concentration of hydrogen peroxide and does not measure the concentration of a slurry.

Although the present invention has been described with reference to the attached drawings and various embodiments, it will be apparent to those skilled in the art that various modifications and variations can be made in the embodiments disclosed herein without departing from the scope of the invention as set forth in the following claims. The features, structures, effects, and the like described in the embodiments are included in at least one embodiment of the present invention, and are not necessarily limited to only one embodiment. Furthermore, the features, structures, effects and the like illustrated in the embodiments can be combined and modified by those skilled in the art to which the embodiments belong. Therefore, it should be understood that the combined and modified embodiments are included in the present invention.

### INDUSTRIAL APPLICABILITY

The present invention provides a device for measuring and adjusting the concentration of a slurry solution, the device being capable of more accurately measuring the concentrations of hydrogen peroxide and a slurry in a slurry solution in real time.

In addition, the present invention provides a device for measuring and adjusting the concentration of a slurry solution, the device being capable of adjusting the concentrations of hydrogen peroxide and a slurry in a slurry solution using measured hydrogen peroxide and slurry concentrations.

In addition, the present invention provides a device for measuring and adjusting the concentration of a slurry solution, the device being capable of adjusting the concentrations of hydrogen peroxide and a slurry in real time, and thus, maintaining the concentrations of the hydrogen peroxide and the slurry constant, thereby preventing defects in a CMP process.

1. A device for measuring the concentration of a slurry solution, comprising:
a sensor part comprising a first sensor for measuring the conductivity of a solution, a second sensor for measuring an ultrasonic wave propagation velocity of the solution, and a third sensor for measuring the absorbance of the solution; and
a concentration measurer configured to analyze the conductivity, ultrasonic wave propagation velocity, and absorbance input from the sensor part and measure the concentrations of hydrogen peroxide and a slurry in the solution in real time.

2. The device according to claim 1, wherein the concentration measurer makes Equation 4 using the concentration of the hydrogen peroxide and the concentration and the conductivity of the slurry, Equation 5 using the concentration of the hydrogen peroxide and the concentration and the ultrasonic wave propagation velocity of the slurry, and Equation 6 using the concentration of the hydrogen peroxide and the concentration and the absorbance of the slurry, analyzes Equations 4 to 6, and measures the concentration of the hydrogen peroxide and the concentration of the slurry.

3. The device according to claim 2, wherein the concentration of the hydrogen peroxide and the concentration of the slurry are measured by any one of a combination of Equations 4 and 5, a combination of Equations 5 and 6, a combination of Equations 4 and 6, and a combination of Equations 4 to 6.

4. The device according to claim 1, wherein the concentration of the hydrogen peroxide and the concentration of the slurry are measured through multiple regression analysis.

5. The device according to claim 1, wherein, by the concentration measurer, the concentration of the hydrogen peroxide and the concentration of the slurry are simultaneously measured in real time.

6. A device for measuring and adjusting the concentration of a slurry solution, comprising:
a sensor part comprising a first sensor for measuring the conductivity of a solution, a second sensor for measuring an ultrasonic wave propagation velocity of the solution, and a third sensor for measuring the absorbance of the solution;
a concentration measurer configured to analyze the conductivity, ultrasonic wave propagation velocity, and absorbance input from the sensor part and measure the concentrations of hydrogen peroxide and a slurry in the solution in real time; and
a concentration adjuster configured to receive input of information on the concentration of the hydrogen peroxide and the concentration of the slurry from the concentration measurer and adjust at least one of the amount of the hydrogen peroxide, the amount of the slurry, and the amount of water such that the concentration of the hydrogen peroxide and the concentration of the slurry are within a predetermined range.

7. The device according to claim 6, wherein the concentration adjuster comprises a controller configured to compare the input hydrogen peroxide and slurry concentrations to the predetermined range and calculate the amount of the hydrogen peroxide, the amount of the slurry, and the amount of the water to be adjusted; a hydrogen peroxide supplier configured to supply hydrogen peroxide according to calculation of the controller; a slurry supplier configured to supply a slurry according to calculation of the controller; and a water supplier configured to supply water according to calculation of the controller.

8. The device according to claim 6, wherein the concentration adjuster receives input of information on the concentration of the hydrogen peroxide and the concentration of the slurry in real time.

9. The device according to claim 6, wherein the concentration adjuster adjusts the concentration of the hydrogen peroxide and the concentration of the slurry in real time.
